(19) United States
(12) Patent Application Publication
(10) Pub. No.: US 2005/0086816 A1
(43) Pub. Date: Apr. 28, 2005

(54) Apparatus for writing in metal

(76) Inventor: Gunther Siegel, La Grangeville, NY (US)

Correspondence Address: Joseph B. Taphorn;HAGAN Farms, 8 Scenic Dr, Poughkeepsie, NY, 12603-5521, US

(21) Appl. No.: 11/006,653

(22) Filed: Dec. 8, 2004

Related U.S. Application Data
(62) Division of application No. 10/159,198, filed on May 30, 2002.

(51) Int. Cl. B43L 13/00

(52) U.S. Cl. 33/18.1; 72/76

(57) ABSTRACT

A computer-controlled machine having a driven rotary chuck writes symbols on the hard surface of a workpiece using an impact device to displace material at workpiece sites corresponding to spots in a virtual pattern and series of virtual patterns of symbols. The machine mounts a workpiece in a position to be impacted by the device, and equipment for moving the workpiece so that it may be impacted at different sites corresponding to virtual pattern spots defined by programming in the machine's computer. The impact device comprises a rotatable driven element which is mounted in the machine rotary chuck, a housing journaling the driven element and held against rotation, an impact element in the housing having a home position from which it is movable, and a mechanism in the housing for converting the rotary motion of the driven element into longitudinal movement of the impact element to displace material at a workpiece site.

### DIVISIONAL PATENT APPLICATION

This patent application is a division of patent application Ser. No. 10/159,198 filed May 30, 2002 by Gunther Siegel for “Apparatus for Writing in Metal”.

### FIELD OF THE INVENTION

This invention relates to apparatus for writing symbols permanently on hard surfaces such as on metal or the like, and more particularly to apparatus for marking such hard surfaces by impact.

### BACKGROUND OF THE INVENTION

Computer controlled apparatus, as well as other numerically controlled apparatus (machine tools controlled by punched paper or magnetic tape or the like prepared on computers by programmers) already allow automation to be employed for marking hard surfaces such as those possessed by metal. But existing controlled apparatus requires expensive devices such as cutters, lasers, stampers, or engravers, or cumbersome devices such as vibrators which must be supplemented by pneumatic or electrical equipment, to mark hard surfaces permanently and which wear out rather quickly and are somewhat slow. Moreover, high quality printing is difficult to obtain.

### PRIOR ART

The prior art includes the aforementioned computer controlled and other numerically controlled apparatus.

### SUMMARY OF THE INVENTION

Accordingly it is an object of the invention to provide less expensive apparatus for writing symbols permanently on hard surfaces.

A further object of the invention to provide apparatus and method for effecting more elegant permanent writing on hard surfaces.

Another object of the invention is to provide faster apparatus and method for writing symbols permanently on hard surfaces.

Yet another object of the invention to provide longer-life apparatus for writing symbols permanently on hard surfaces.

Still another object of the invention to provide a simpler-to-install apparatus for writing symbols permanently on hard surfaces.

An additional object of the invention is to provide a device and method for inexpensively adapting existing computer controlled and other numerically controlled apparatus to write symbols permanently on hard surfaces.

A further object of the invention to provide less cumbersome apparatus for writing symbols permanently on hard surfaces.

Still another object of the invention is to provide a less cumbersome and more-wieldy device for adapting existing computer controlled and other numerically controlled apparatus to write symbols permanently on hard surfaces.

Yet another object of the invention is to provide higher quality permanent printing on hard surfaces.

The objects of the invention are achieved by enabling a computer-controlled or other numerically-controlled machine or method to impact a hard surface at a succession of sites corresponding to a succession of spots within a virtual pattern or series of virtual patterns representing various symbols and displace material thereat, to make a collection of marks reflecting the same symbols. The width and nature of the individual marks at the various sites can be pre-selected. The depths of the marks can be controlled by the machine. The size and the spacing of the symbols from each other can be controlled by the machine or method. Thus various figures, letters and other symbols, patterns or visual compositions may be written on hard surfaces in every thing from very fine lines to spaced large points, to communicate any expression.

A computer controlled or other numerically controlled machine is enabled to mark a hard surface at a site by providing the machine with an impact device that uses the rotary motion of the machine's chuck into which it is easily mounted.

To this end the impact device has as its upper end a drive element adapted to be received in the controlled-machine rotary chuck. This device drive element projects upward from a housing that journals it and that bears a latch mechanism that coacts with the machine to hold the housing against rotation. The lower end of the drive element carries a disc centrally via its upper face. The disc on its lower face mounts cam lobe elements which coact with follower rollers journaled horizontally on a longitudinally movable rod biased to an upward position in the housing in which the follower rollers engage the disc lower face. The lower end of the rod extends from the housing and carries on its bottom, via a conventional chuck, an impact marking tip. Rotation of the device drive element causes the cam elements on the disc lower face to sharply push down the follower rollers on the upwardly biased longitudinally movable rod so that the marking tip on its bottom delivers a material-displacing impact blow at a site upon the object (workpiece) to be marked between each positioning of the workpiece. Rotation of the machine chuck and movement of the table bearing the workpiece in X and Y directions to position different sites momentarily below the impact device, are coordinated through appropriate programming. The different sites are specified via virtual patterns of symbols defined to the machines via programming and the message to be recorded.

A feature of the invention is that the quality of the printing is better. For one, the marking tip can be readily changed as upon wear or when marks or sites of different natures, widths, or depths are desired. Different character faces can be readily achieved by substituting marking tips having different end shapes such as point, round, or square, or by programming. Different depths can also be obtained by suitably programming the computer of the computer-controlled machine, or by inserting different input elements such as tapes in a numerically-controlled machine. Different spacings of the sites are precisely defined by suitable programming or other inputs. Marks of different natures can be obtained by substituting marking tips with different end shapes. And of course the writings to be effected are also controlled by computer programming or input elements in conventional fashion.

An advantage of the invention is that the mechanical design of the impact device provides for longer life of the writing component. Breakage is minimized.

Another advantage of the invention is that it can write as fast as the controlled machined can operate.

Still another advantage of the invention is that it eliminates handling the workpiece twice when different style writings are desired thereon. The impact marking tip can be readily substituted for the previous one in the device, and the impact device itself can be readily substituted for the previous one in the machine chuck holder if more robust or more refined printing is desired. The impact device driven element fits into any CNC holder or straight shank.

A further advantage of the invention is that the impact device is uncluttered with other external connections. This unclutteredness provides the freedom to place the device in an Automatic Tool Changer on the machine wherein it may be called upon anytime it is needed.

### BRIEF DESCRIPTION OF DRAWINGS OF THE PREFERRED EMBODIMENT

These and other objects, features and advantages of the invention will become more apparent from a consideration of the following description of a preferred embodiment of the invention, when considered with the appended drawings wherein:

FIG. 1 is a diagrammatic side view of a computer-controlled machine embodying the invention;

FIG. 2 is a side view of an upright preferred embodiment of the impact device of the invention;

FIG. 3 is a vertical cross-sectional view of a portion of the impact device shown in FIG. 2; and

FIG. 4 shows a collection of different renditions of a symbol (the numeral 5) formed by impacting the spots of a virtual pattern on the corresponding sites of a workpiece with marking tips having differently shaped ends such as point, round, or square, or by different programming.

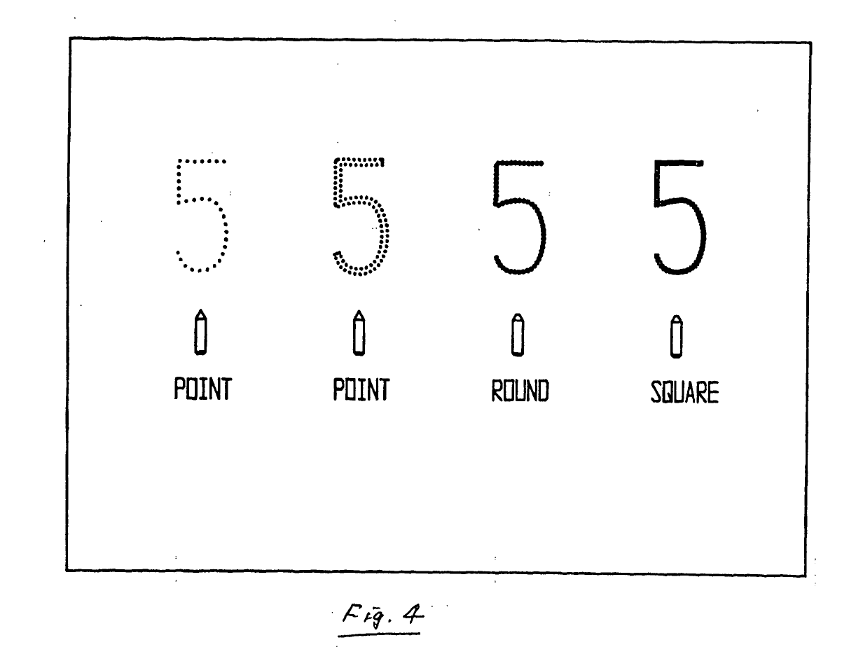

### DETAILED DESCRIPTION OF THE INVENTION PREFERRED EMBODIMENT

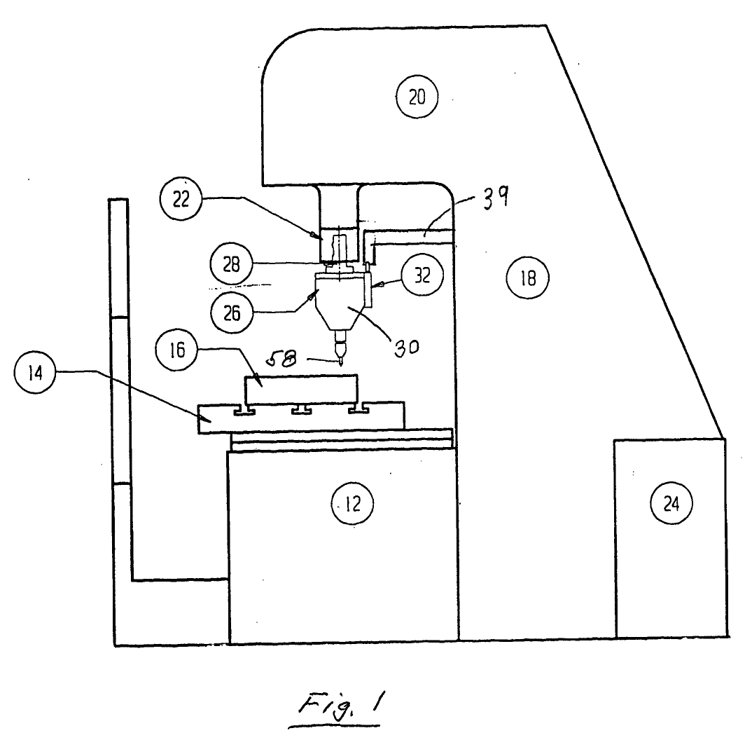

Referring now more particularly to FIG. 1, there is shown therein a conventional computer-controlled machine adapted according to applicant's invention. The computer-controlled machine, generally indicated by the numeral 10, includes a base 12 supporting for movement in X and Y directions a table 14 mounting a workpiece 16. The base 12 supports via an upright 18 at one end, a horizontally-extending arm 20 from which depends at its free end a rotary driven chuck 22. Rotary motion of the chuck 22 and X and Y movement of the table 14 to position the workpiece 16 under the chuck 22 are controlled by a computer 24 suitably programmed in conventional fashion.

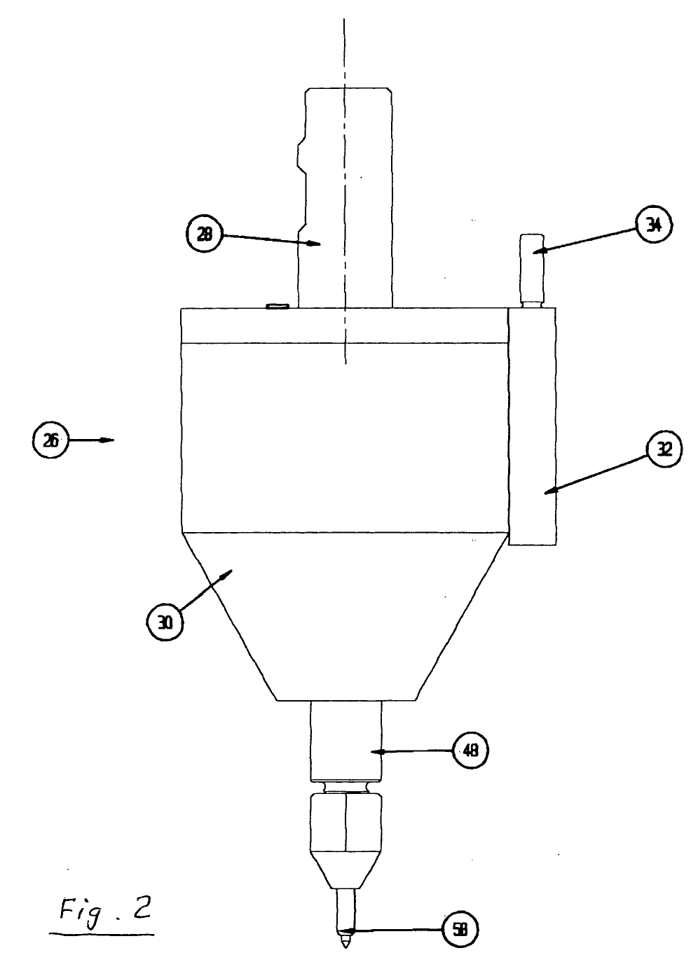

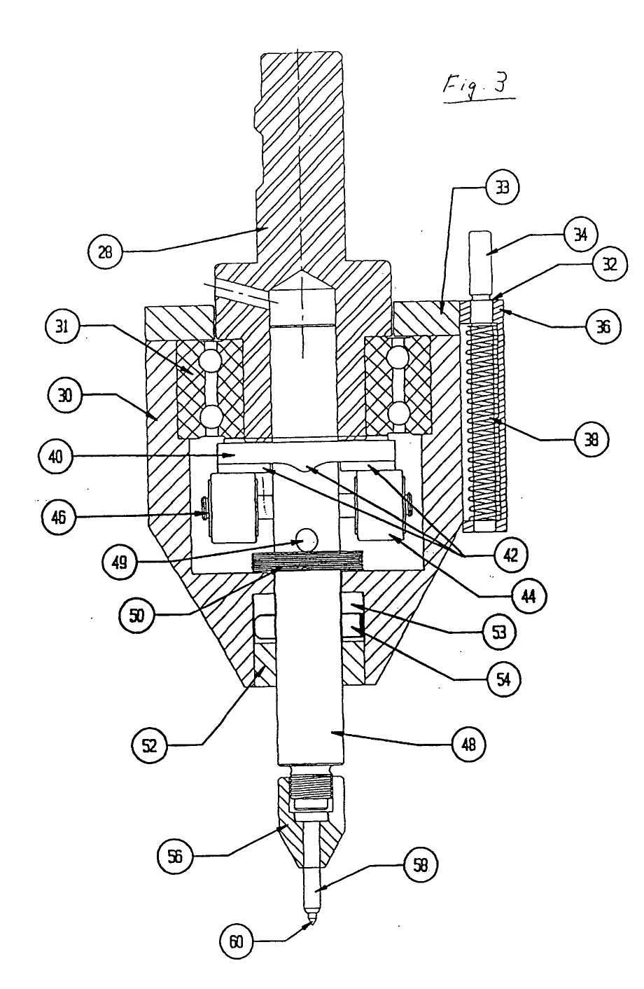

The computer controlled machine 10 is adapted for impact writing by mounting an impact device (FIGS. 1-3) generally indicated by the numeral 26 on the machine chuck 22. The impact device has as its upper end a drive element 28 complementarily-shaped so as to be fixedly received in the controlled-machine rotary chuck 22. This device drive element 28 projects upward from a housing 30 (FIGS. 1-3) in which it is journaled via roller bearings 31 and end plate 33 and a disk 40. The housing 30 also bears a latch mechanism generally indicated by the numeral 32 for holding the housing in a fixed or non-rotating position with respect to the machine 10.

The latch mechanism 32 includes a headed pin 34 slidably mouned in a side housing 36 on the housing 30 and biased by a spring 38 to an upper home position and one in which it would have been received in a machine tool aperture in a machine horizontal-extending arm 39 on upright 18 to hold the housing 30 against rotation.

The lower end of the impact-device drive element 28 fixedly carries the disc 40 centrally on the latter's upper face. The disc 40 on its lower face mounts four equally-spaced cam lobes 42 (though other numbers such as two or six could be used) which coact with follower rollers 44 journaled on horizontal studs 46 on a longitudinally-slidable but non-rotating vertical rod or actuating shaft 48 biased by spring washers 50 to an upward position determined by the cam disc 40 in the housing 30. The spring washers react between the housing 30 and a stud 49 on the shaft 48. The lower end of rod 48 slidably passes out of the housing 30 via a bushing 52 mounted in the lower end of the housing 30 secured in a rectangular-in-cross-section opening 53 therein. Within the rectangular-in-cross-section opening 53 and fixed to the rod 48 is a fixed pin 54 which precludes the rod from rotating under the influence of the cam disc 40. The length of the opening 53 is such as to accommodate the range of movement of the rod 48 and its element 54 therein under cam lobe 42 and spring washers 50 action.

The lower end of the longitudinally slidable vertical rod 48 extends from the housing 30 and carries on its bottom, via a conventional chuck 56, a metal marking stylus 58. A tip 60 at the end thereof and made from carbide allows very hard material to be marked. A tip 60 may have various end shapes such as point, round, or square.

It will be appreciated that rotation of the device drive element 28 causes the cam elements 42 on the disc 40 lower face to sharply push down the follower rollers 44 on the upwardly biased longitudinally movable rod 48 so that the marking tip 60 on the bottom stylus mounted thereon delivers impact blows upon the object (workpiece) to be marked.

It will also be appreciated that the number of cam elements or lobes 42 on the disc 40 lower face may be any multiple of two, such as two, four, six, or eight.

To do impact writing, the impact device might first be mounted in the computer-controlled machine 10 by placing its drive element 28 in the machine's rotary driven chuck 22. Thereafter a workpiece 16 such as a piece of metal might be placed on the X and Y direction-movable table 14 of the machine 10, a stylus 58 with an appropriate carbide tip inserted in the impact device chuck 56, and an appropriate program lined up for the machine, and the machine activated in conventional fashion. The machine would then move the table 14 to locate a workpiece first site corresponding to the first spot of the virtual pattern of a selected symbol, beneath the impact device 26, and rotate its chuck 22. Rotation of the machine chuck 22 would rotate the drive element 28 of the impact device 26 and its cam disc 40 whose lobes 42 would then drive down through the follower rollers 46 the rod 48 against the bias of the spring washers 50 to where the carbide tip 60 impacted the workpiece 16 to displace material and mark a site thereon, all of the parts being appropriately dimensioned.

Continued rotation of the cam disc 40 removes the instant driving lobes 42 from above the follower rollers 44, allowing the spring washers 50 to raise the driven rod 48 and its stylus 58. The computer-controlled machine 10 would now be free to position the movable table 14 to were another workpiece site corresponding to another spot in the virtual pattern of same symbol or to another spot in the virtual pattern of a second symbol as mandated for the desired writing and style, may be impacted.

While there has been shown and described a preferred embodiment of the invention, it will be clear to others experienced in the art, that other and different applications may be made of the principles of the invention. It is therefore desired to be limited only by the scope or spirit of the appended claims.

21. A marking device for use with a CNC machine or other machine tool, said marking device comprising:
a. a housing;
b. a reciprocative stylus supported by the housing and extensible beyond the housing to mark a part external to the housing;
c. a stylus driving means supported within the housing for controllably causing the stylus to reciprocate; and
d. a machine tool interface means operably connected to the housing and to the stylus driving means for operating the stylus driving means, said machine tool interface means extending beyond the housing and being configured to be engaged and driven by the CNC machine or other machine tool, wherein a rate of stylus reciprocation is a direct function of CNC machine or other machine tool operation.

22. The marking device of claim 21 further comprising a rotation prevention means attached to the housing for preventing the housing from rotating during operation of the marking device at least subsequent an initial period of rotation.

23. The marking device of claim 21 wherein:
a. the stylus driving means comprises a rotatable cam having at least one lobe disposed on an underside thereof and
b. the reciprocative stylus normally tracks along the underside of the cam.

24. A marking device for use with a CNC machine or other machine tool, said marking device comprising:
a. a housing;
b. a shaft rotatably supported within the housing, said shaft extending beyond the housing and being configured to be engaged and rotated by the CNC machine or other machine tool;
c. a cam attached to the shaft and positioned within an interior of the housing, said cam having a least one lobe disposed on an underside thereof, and
d. a reciprocative stylus supported by the housing, and said stylus normally tracking along the underside of the cam, and being moveable to a displaced position, wherein; when the at least one lobe contacts the stylus, a portion of the stylus moves away from the housing; as the shaft and cam rotate with the housing remaining stationary, the at least one lobe periodically contacts the stylus, forcing it to axially reciprocate and mark a workpiece located external the housing; and a rate of stylus reciprocation is a direct function of CNC machine or other machine tool operation, by virtue of the CNC machine or other machine tool rotating the shaft.

25. The marking device of claim 24 wherein the housing has a through-bore, and the stylus extends from the interior of the housing into the through-bore and is slidable therein.

26. The marking device of claim 25 wherein the stylus comprises:
a. a cylindrical stylus shaft having a first end and a second end;
b. an anvil attached to the first end of the stylus for tracking along the underside of the cam; and
c. a marking tip attached to the second end of the stylus shaft.

27. The marking device of claim 26 wherein the stylus is biased via a spring concentrically disposed about the stylus shaft and positioned between the anvil and the housing.

28. The marking device of claim 24 wherein the at least one lobe is a generally trapezoidal solid having sloping sides that are tangentially oriented to the cam.

29. The marking device of claim 28 wherein the lobe sides slope at substantially 15 degrees.

30. The marking device of clam 24 further comprising a stop rod attached to the outside of the housing and extending away therefrom; whereby when the shaft is rotated by the CNC machine or other machine tool and the housing initially rotates along with it, the stop rod eventually contacts the CNC machine or other machine tool and prevents the housing from further rotating.

31. The marking device of clam 24 wherein the housing is generally cylindrical and comprises a tubular body; a top plate attached to a first end of the body; and a bottom plate attached to the second end of the body.

32. A marking device or use with a CNC machine or other machine tool, said marking device comprising:
a. a housing having an interior and a through-bore;
b. a rotatable shaft having one end supported within the housing and the other end extending through and beyond an opening in the housing, said shaft being configured to be engaged and rotated by the CNC machine or other machine tool;
c. a cam attached to the shaft and positioned within the interior of the housing, said cam having at least one lobe disposed on an underside thereof; and
d. a stylus, slidably supported within the through-bore, said stylus having a first, anvil end extending into the housing and a second, marking end, wherein the stylus is biased so that the first end normally tracks along the underside of the cam, wherein the second end partially extends past the housing when the at least one lobe strikes the first end of the stylus; and wherein a rate of stylus reciprocation is a direct function of CNC machine or other machine tool operation, by virtue of the CNC machine or other machine tool rotating the shaft.

33. The marking device of claim 32 wherein the through-bore is provided in a guide attached to the housing and extending from the interior of the housing to outside the housing.

34. The marking device of claim 32 wherein the anvil end of the stylus and the marking end of the stylus are connected via a cylindrical stylus shaft.

35. The marking device of claim 34 wherein the stylus is biased via a spring concentrically disposed about the stylus shaft and positioned between the anvil and the housing.

36. The marking device of claim 34 wherein the marking device is conical.

37. The marking device of claim 32 wherein the at least one lobe is a generally trapezoidal solid having sloping sides that are tangentially oriented to the cam.

38. The marking device of claim 37 wherein there are two lobes spaced equidistantly around the underside of the cam.

39. The marking device of claim 37 wherein there are four lobes spaced equidistantly around the underside of the cam.

40. The marking device of claim 37 wherein the lobe sides slope at substantially 15 degrees.

41. The marking device of claim 32 further comprising a stop rod attached to the outside of the housing and extending away therefrom, whereby when the shaft is rotated by the CNC machine or other machine tool and the housing initially rotates along with it, the stop rod eventually contacts the CNC machine or other machine tool and prevents the housing from further rotating.

42. The marking device of claim 32 wherein the housing is generally cylindrical and comprises a tubular body, a top plate attached to and covering a first end of the body, and a bottom plate attached to and covering a second end of the body.

43. A marking device for use with a CNC machine or other machine tool, said marking device comprising:
a. a housing;
b. a shaft rotatably connected to the housing and extending beyond the housing and being configured to be engaged and rotated by the CNC machine or other machine tool;
c. a cam attached to the shaft and positioned within an interior of the housing, said cam having at least one lobe disposed on an underside thereof; and
d. a reciprocative stylus supported by the housing and normally tracking along the underside of the cam, wherein a portion of said stylus is extensible beyond the housing to mark a part external to the housing when the stylus is struck by at least one lobe, and wherein a rate of stylus reciprocation is a direct function of CNC machine or other machine tool operation, by virtue of the CNC machine or other machine tool rotating the shaft.

44. A marking device for use with a CNC machine or other machine tool, said marking device comprising:
a. a housing having an interior and a through-bore;
b. a shaft rotatably connected to the housing and extending beyond the housing and being configured to be engaged and rotated by the CNC machine or other machine tool;
c. a cam attached to the shaft and positioned within an interior of the housing, said cam having at least one lobe disposed on an underside thereof; and
d. a stylus biased to normally track along the underside of the cam and extending from the housing interior into the through-bore and slidable therein, wherein the stylus is dimensioned to partially extend past the housing when the at least one lobe strikes the stylus, and wherein a rate of stylus reciprocation is a direct function of CNC machine or other machine tool operation, by virtue of the CNC machine or other machine tool rotating the shaft.

45. A marking device for use with a CNC machine or other machine tool, said marking device comprising:
a. a housing having a top, and a bottom opposite the top;
b. a shaft rotatably connected to the housing and configured to be rotated by a spindle portion of the CNC machine or other machine tool, wherein shaft rotation is a direct function of CNC machine or other machine tool operation;
c. a cam attached to the shaft and positioned within an interior of the housing, said cam having at least one lobe disposed on an underside thereof, and
d. a reciprocative stylus supported y the housing and normally tracking along the underside of the cam, wherein:
i. the stylus is extensible beyond the housing bottom to mark a part beneath the housing bottom when the stylus is struck by the at least one lobe; and
ii. the stylus is parallel to the shaft, such that the marking device is suitable for marking items generally longitudinally aligned with the shaft.
